(19) United States
(12) Patent Application Publication
(10) Pub. No.: US 2023/0028245 A1
(43) Pub. Date: Jan. 26, 2023

(54) SOLID STATE BATTERY

(71) Applicant: TeraWatt Technology K.K., Yokohama-shi (JP)

(72) Inventors: Juichi Arai, Yokohama-shi (JP); Ken Ogata, Yokohama-shi (JP)

(73) Assignee: TeraWatt Technology K.K., Yokohama-shi (JP)

(21) Appl. No.: 17/953,398

(22) Filed: Sep. 27, 2022

Related U.S. Application Data
(63) Continuation of application No. PCT/JP2020/014242, filed on Mar. 27, 2020.

(51) Int. Cl. H01M 10/0565; H01M 10/0525; H01M 10/44; H01M 4/134

(52) U.S. Cl. CPC H01M 10/0565; H01M 10/0525; H01M 10/44; H01M 4/134

(57) ABSTRACT

It is an object of the present invention to provide a solid-state battery having high energy density and excellent cycle property. The solid-state battery comprises a positive electrode, a solid electrolyte, and a negative electrode that is free of a negative-electrode active material. The solid electrolyte has a solid polymer electrolyte layer, and a functional layer that has a surface facing at least the negative electrode and that suppresses the formation of dendrites on the surface of the negative electrode.

### CROSS REFERENCES TO RELATED APPLICATIONS

This application is a continuation of International Application No. PCT/JP/2020/014242, filed Mar. 27, 2020, the entire contents of which are incorporated herein by reference.

### TECHNICAL FIELD

The present invention relates to a solid-state battery.

### BACKGROUND

In recent years, techniques for converting natural energy such as solar power or wind power into electric energy have attracted more attention. Accordingly, various solid-state batteries have been developed as storage devices that are safe and that can store a large amount of electric energy.

Among these, secondary batteries that charge and discharge by transferring metal ions between a positive electrode and a negative electrode are known to have a high voltage and high energy density, and are usually lithium ion secondary batteries. In a typical lithium ion secondary battery, an active material capable of retaining lithium is introduced into the positive electrode and the negative electrode, and charging and discharging are performed by exchanging lithium ions between the positive electrode active material and the negative electrode active material. A lithium metal secondary battery has also been developed that does not use an active material in the negative electrode, but retains lithium by depositing lithium metal on the surface of the negative electrode.

For example, Patent Document 1 discloses a high energy density, high power lithium metal anode secondary battery with a volumetric energy density greater than 1000 Wh/L and/or a mass energy density greater than 350 Wh/kg when discharged at room temperature at a rate of at least 1C. Patent Document 1 discloses that an ultrathin lithium metal anode is used to realize such a lithium metal anode secondary battery.

Patent Document 2 discloses a lithium secondary battery containing a positive electrode, a negative electrode, a separation film interposed between the electrodes, and an electrolyte. In the negative electrode of this lithium secondary battery, metal particles are formed on the negative electrode current collector and move from the positive electrode during charging to form lithium metal on the negative electrode current collector in the negative electrode. Patent Document 2 discloses that this lithium secondary battery can solve problems caused by the reactivity of lithium metal and problems that occur during the assembly process, and has improved performance and a longer service life.

### CITATION LIST

### Patent Literature

Patent Document 1: JP 2019-517722 A
Patent Document 2: JP 2019-537226 A

### SUMMARY OF INVENTION

### Technical Problem

When the present inventors examined conventional solid-state batteries such as those described in the patent documents listed above, they found that either the energy density or the cycle property was inadequate.

For example, a typical secondary battery that charges and discharges by transferring metal ions between a positive electrode active material and a negative electrode active material does not have sufficient energy density. Meanwhile, in lithium metal secondary batteries that retain lithium by depositing lithium metal on the surface of the negative electrode, such as those described in the patent documents listed above, dendrites tend to form on the surface of the negative electrode after repeated charging and discharging, which makes short-circuiting and reduced capacity more likely to occur. As a result, the cycle property is not sufficient.

A method has also been developed of applying a large amount of physical pressure to a lithium metal secondary battery to keep the interface between the negative electrode and the separator under high pressure and suppress discrete growth during lithium metal precipitation. However, because a large mechanical mechanism is required to apply such a high level of pressure, the weight and volume of the battery increase as a whole, and the energy density decreases.

In view of these problems, it is an object of the present invention to provide a solid-state battery having high energy density and improved cycle property.

### Solution to Problem

One aspect of the present invention is a solid-state battery comprising a positive electrode, a solid electrolyte, and a negative electrode that is free of a negative-electrode active material, wherein the solid electrolyte has a solid polymer electrolyte layer, and a functional layer that has a surface facing at least the negative electrode and that suppresses the formation of dendrites on the surface of the negative electrode.

When a negative electrode containing no negative electrode active material is used, metal is deposited on the surface of the negative electrode and the deposited metal is dissolved during charging and discharging. This increases the energy density. When a solid electrolyte with the functional layer described above is used, formation of dendrites on the surface of the negative electrode can be suppressed when metal is deposited on the surface of the negative electrode and the deposited metal is dissolved. As a result, problems such as short-circuiting and reduced capacity due to dendrites forming on the surface of the negative electrode can be suppressed, and cycle property is excellent.

The functional layer may be arranged on one side of the solid polymer electrolyte layer or on both sides of the solid polymer electrolyte layer. When the functional layer is arranged on both sides of the solid polymer electrolyte layer, growth of dendrites can be further suppressed. This makes it possible to keep dendrites that have formed on the surface of the negative electrode from reaching the positive electrode and causing short-circuiting inside the battery.

The functional layer may have a portion arranged so as to traverse the solid polymer electrolyte layer. In this aspect of the present invention, uniform lithium ion conduction occurs at least in the traversing portion, and a more uniform supply of lithium ions is provided in the in-plane direction on the surface of the negative electrode. This makes it possible to further suppress the formation of dendrites on the surface of the negative electrode.

The solid-state battery is preferably a lithium secondary battery in which charging and discharging are performed by depositing lithium metal on the surface of the negative electrode and dissolving the deposited lithium. In this aspect of the present invention, the energy density is further increased.

The negative electrode is preferably a lithium-free electrode. In this aspect of the present invention, use of highly flammable lithium metal is not required in the production process, and safety and productivity are further improved.

In the solid-state battery, lithium foil is preferably not formed between the solid electrolyte and the negative electrode prior to the initial charge. In this aspect of the present invention, use of highly flammable lithium metal is not required in the production process, and safety and productivity are further improved.

The solid polymer electrolyte layer preferably has ionic conductivity and not electron conductivity, and has conductivity of 0.10 mS/cm or more, and the functional layer has at least one of ionic conductivity and electron conductivity. When the solid polymer electrolyte layer preferably has ionic conductivity and not electron conductivity, the internal resistance of the solid-state battery is further reduced, and short-circuiting inside the solid-state battery can be further suppressed. As a result, the solid-state battery has a higher energy density and more excellent cycle property. When the functional layer has at least one of ionic conductivity and electron conductivity, the voltage applied to the interface between the functional layer and the negative electrode becomes more uniform in the in-plane direction of the negative electrode. A more uniform supply of lithium ions occurs in the in-plane direction, and formation of dendrites on the surface of the negative electrode can be further suppressed.

The solid polymer electrolyte layer may contain a first resin and a lithium salt, the first resin being at least one type selected from a group consisting of resins having an ethylene oxide unit in the main chain and/or a side chain, acrylic resins, vinyl resins, ester resins, and nylon resins, and the functional layer may contain a second resin, a lithium salt, and a filler, the second resin being at least one type selected from a group consisting of fluororesins having fluorine in the main chain, aromatic resins having an aromatic ring in the main chain, imide resins, amide resins, and aramid resins.

The filler is preferably an inorganic salt. In this aspect of the present invention, interaction with the carrier metal is further improved and dendrite formation can be further suppressed.

The amount of lithium salt in the functional layer is preferably 1 part by mass or more and 50 parts by mass or less with respect to 100 parts by mass of the second resin. In this aspect of the present invention, lithium ions are supplied more uniformly in the in-plane direction to the surface of the negative electrode, and more uniform lithium metal foil is deposited in the in-plane direction.

The amount of filler is preferably 1 part by mass or more and 30 parts by mass or less with respect to 100 parts by mass of the second resin. In this aspect of the present invention, growth of dendrites can be further suppressed.

The average thickness of the functional layer facing the negative electrode is preferably 0.5 μm or more and 10.0 μm or less. In this aspect of the present invention, growth of dendrites can be further suppressed.

The positive electrode may have a positive electrode active material.

### Effect of Invention

The present invention is able to provide a solid-state battery having high energy density and excellent cycle property.

### BRIEF DESCRIPTION OF DRAWINGS

FIG. 1 is a schematic diagram of the solid-state battery in the first embodiment.

FIG. 2 is a schematic diagram of the solid-state battery in this embodiment during use.

FIG. 3 is a schematic diagram of the solid-state battery in the second embodiment.

FIG. 4A is a schematic diagram of the solid-state battery in the third embodiment.

FIG. 4B is a schematic diagram of the solid-state battery in the fourth embodiment.

### DESCRIPTION OF EMBODIMENTS

Embodiments of the present invention (“embodiments”) will now be described with reference to the drawings when necessary. In the drawings, identical elements are designated by the same reference numbers, and redundant descriptions of these elements have been omitted. Positional relationships such as up, down, left, and right are based on the positional relationship shown in the drawings unless otherwise specified. The dimensional ratios shown in the drawings are not limited to the depicted ratios.

### 1st Embodiment

### Solid-State Battery

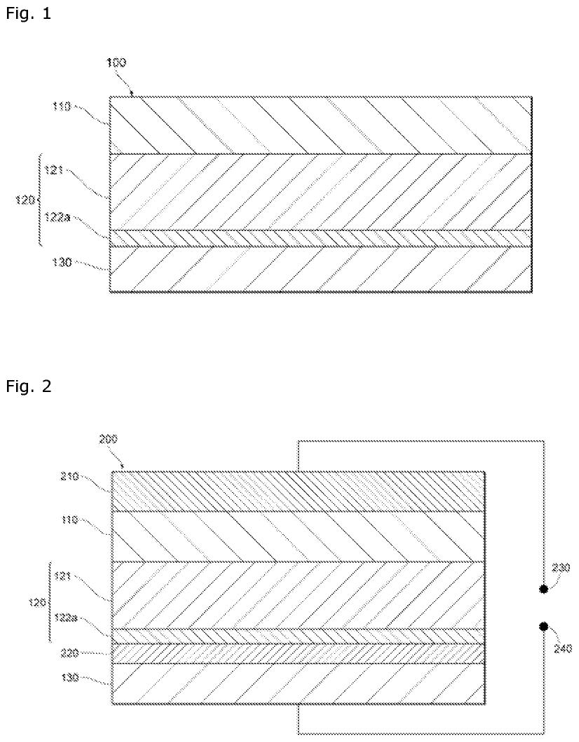

The solid-state battery 100 in the first embodiment shown in FIG. 1 includes a positive electrode 110, a solid electrolyte 120, and a negative electrode 130 that is free of a negative electrode active material. The solid electrolyte 120 has a solid polymer electrolyte layer 121 and a functional layer 122a that has a surface facing at least the negative electrode 130 and that suppresses the formation of dendrites on the surface of the negative electrode 130.

### Positive Electrode

There are no particular restrictions on the positive electrode 110 and it can be any material commonly used in solid-state batteries. This can be selected depending on the intended application for the solid-state battery and the type of carrier metal used. From the standpoint of increasing the stability and output voltage of the solid-state battery 100, the positive electrode 110 preferably contains a positive electrode active material.

In the present specification, “positive electrode active material” refers to the substance in the battery used to hold the metal ions serving as the charge carrier or the metal (“carrier metal”) corresponding to these metal ions, and is also referred to as the carrier metal host substance.

Examples of positive electrode active materials include, but are not limited to, metal oxides and metal phosphates. Examples of metal oxides include, but are not limited to, cobalt oxide-based compounds, manganese oxide-based compounds, and nickel oxide-based compounds. Examples of metal phosphate include, but are not limited to, iron phosphate-based compounds and cobalt phosphate-based compounds. When the carrier metal is lithium ions, typical examples of positive electrode active materials include LiCoO₂, LiNiₓCo_{y}Mn_{z}O₂ (x+y+z=1), LiNiₓMn_{y}O₂ (x+y=1), LiNiO₂, LiMn₂O₄, LiFePO₄, LiCoPO₄, FeF₃, LiFeOF, LiNiOF, and TiS₂. The positive electrode active materials mentioned above can be used alone or in combinations of two or more.

The positive electrode 110 may contain components other than a positive electrode active material. Examples of these components include, but are not limited to, commonly used conductive aids, binders, solid polymer electrolytes, and inorganic solid electrolytes.

### Negative Electrode

The negative electrode 130 does not contain a negative electrode active material. It is difficult to increase the energy density of a solid-state battery with a negative electrode containing a negative electrode active material due to the presence of the negative electrode active material. On the other hand, because the solid-state battery 100 in the present embodiment has a negative electrode 130 that does not contain a negative electrode active material, this problem does not occur. The solid-state battery 100 in the present embodiment has a high energy density because charging and discharging are performed by depositing metal on the surface of the negative electrode 130 and dissolving the deposited metal.

In the present specification, “negative electrode active material” refers to a substance holding the carrier metal on the negative electrode, and may also be referred to as the carrier metal host material. Examples of holding mechanisms include, but are not limited to, intercalation, alloying, and occlusion of metallic clusters.

Examples of negative electrode active materials include, but are not limited to, carbon-based substances, metal oxides, metals, and alloys. Carbon-based substances include, but are not limited to, graphene, graphite, hard carbon, mesoporous carbon, carbon nanotubes, and carbon nanohorns. Examples of metal oxides include, but are not limited to, titanium oxide-based compounds, tin oxide-based compounds, and cobalt oxide-based compounds. There are no particular restrictions on the metal or alloy as long as it can be alloyed with the carrier metal. Examples include silicon, germanium, tin, lead, aluminum, gallium, and alloys containing these.

There are no particular restrictions on the negative electrode 130 as long as it does not contain a negative electrode active material and can be used as a current collector. Examples include metals such as Cu, Al, Li, Ni, Mg, Ti, Au, Ag, Pt, Pd and In, alloys containing these metals, stainless steel, and metal oxides such as fluorine-doped tin oxide (FTO), antimony-doped tin oxide (ATO), and tin-doped indium oxide (ITO). The negative electrode materials mentioned above can be used alone or in combinations of two or more.

The negative electrode 130 is preferably a lithium-free electrode. In this aspect of the present invention, the solid-state battery 100 has increased safety and productivity because use of a highly flammable lithium metal is not required during production. From this standpoint, the negative electrode 130 is preferably Cu or an alloy containing Cu.

### Solid Electrolyte

The solid-state battery 100 includes a solid electrolyte 120. The solid electrolyte 120 includes a solid polymer electrolyte layer 121 and a functional layer 122a that has a surface facing the negative electrode 130 and that suppresses the formation of dendrites on the surface of the negative electrode 130. In a battery containing a liquid electrolyte, the physical pressure applied by the electrolyte to the surface of the negative electrode tends to vary locally due to fluctuations in the liquid. Because the solid-state battery 100 includes a solid electrolyte 120, the pressure applied by the solid electrolyte 120 to the surface of the negative electrode 130 is more uniform, and formation of dendrites on the surface of the negative electrode 130 can be further suppressed.

There are no particular restrictions on the solid polymer electrolyte layer 121 as long as it is a solid polymer electrolyte layer commonly used as a solid electrolyte in a solid battery. However, it preferably has ionic conductivity and no electron conductivity. When the solid polymer electrolyte layer 121 has ionic conductivity and no electron conductivity, internal resistance in the solid-state battery 100 can be further reduced and short-circuiting inside the solid-state battery can be further suppressed. As a result, the solid-state battery 100 has a higher energy density and more excellent cycle property.

The conductivity of the solid polymer electrolyte layer 121 is preferably 0.01 mS/cm or more, more preferably 0.10 mS/cm or more, and even more preferably 1.00 mS/cm or more. When the conductivity of the solid-state polymer electrolyte layer 121 is within this range, the internal resistance of the solid-state battery 100 is further reduced. This increases the energy density of the solid-state battery 100.

The conductivity can be measured using any method common in the art. Also, in order to keep the conductivity of the solid polymer electrolyte layer 121 inside this range, the salt content of the solid polymer electrolyte layer 121 can be adjusted. Raising the salt content of the solid polymer electrolyte layer 121 increases the conductivity of the solid polymer electrolyte layer 121.

The average thickness of the solid polymer electrolyte layer 121 is preferably 10 μm or more and 100 μm or less, more preferably 15 μm or more and 90 μm or less, and even more preferably 20 μm or more and 80 μm or less. When the average thickness of the solid polymer electrolyte layer 121 is within this range, short-circuiting inside the battery can be further suppressed and the internal resistance of the battery can be further reduced. As a result, the solid-state battery 100 has a higher energy density and more excellent cycle property.

The solid polymer electrolyte layer 121 preferably contains a first resin and a lithium salt. The first resin is at least one type selected from a group consisting of resins having an ethylene oxide unit in the main chain and/or a side chain, acrylic resins, vinyl resins, ester resins, and nylon resins. Because the solid polymer electrolyte layer 121 contains one of these resins and lithium salt, it has ionic conductivity and no electron conductivity. As a result, the internal resistance of the solid-state battery 100 can be further reduced, and short-circuiting inside the solid-state battery 100 can be suppressed. Also, because the solid polymer electrolyte layer 121 contains one of these resins and a lithium salt, the ionic conductivity in the solid electrolyte 120 becomes more uniform, which can further suppress formation of dendrites on the surface of the negative electrode 130. As a result, the solid-state battery 100 has a higher energy density and more excellent cycle property. From the same standpoint, the first resin is preferably a resin having an ethylene oxide unit in the main chain and/or the side chain, and more preferably a copolymer of an ethylene oxide and ethylene glycol ether.

Examples of lithium salts that can be used in the solid polymer electrolyte layer 121 include, but are not limited to, LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(O₂C₂H₄)F₂, LiB(OCOCF₃)₄, LiNO₃, and Li₂SO₄. From the standpoint of further improving the cycle property of the solid-state battery 100, the lithium salt is preferably LiN(SO₂F)₂, LiN(SO₂CF₃)₂, LiN(SO₂CF₃CF₃)₂, or LiF. These lithium salts may be used alone or in combinations of two or more.

The amount of first resin in the solid polymer electrolyte layer 121 may be 20% by mass or more and 95% by mass or less, 30% by mass or more and 80% by mass or less, or 40% by mass or more and 70% by mass or less with respect to the overall mass of the solid polymer electrolyte layer.

Generally, the ratio of resin to lithium salt in the solid polymer electrolyte layer is determined by the ratio of oxygen atoms in the resin to lithium atoms in the lithium salt ([Li]/[O]). In the solid polymer electrolyte layer 121 of the present embodiment, the ratio of first resin to lithium salt in terms of the ([Li]/[O]) ratio is preferably 0.02 or more and 0.20 or less, more preferably 0.03 or more and 0.15 or less, and even more preferably 0.04 or more and 0.12 or less. When the ([Li]/[O]) ratio is in this range, the conductivity of the solid polymer electrolyte layer 121 can be set to the preferred range mentioned above.

The solid polymer electrolyte layer 121 may contain a first resin, a lithium salt, and other components. These components include, but are not limited to, resins other than the first resin, salts other than lithium salts, metal complexes, ionic liquids, and solvents.

Examples of resins other than the first resin include, but are not limited to, polysiloxane, polyphosphazene, polyvinylidene fluoride, polymethylmethacrylate, polyamide, polyimide, aramid, polylactic acid, polyethylene, polystyrene, polyurethane, polypropylene, polybutylene, polyacetal, polysulfone, and polytetrafluoroethylene. Examples of salts other than lithium salts include, but are limited to, salts of Na, K, Ca, and Mg. These resins other than the first resin and salts other than lithium salts can be used alone or in combinations of two or more.

Metal complexes include, but are not limited to, V, Fe, and Cr metal complexes.

Ionic solution cations include, but are not limited to, tetraalkylammonium, dialkylimidazolium, trialkylimidazolium, tetraalkylimidazolium, alkylpyridinium, dialkylpyrrolidinium, dialkylpiperidinium, tetraalkylphosphonium, and trialkylsulfonium. Ionic solution anions include, but are not limited to, BF₄⁻, B(CN)₄—, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂—, N(COCF₃)(SO₂CF₃)⁻, N(SO₂F)₂⁻, N(CN)₂⁻, C(CN)₃⁻, SCN⁻, and SeCN⁻. These ionic solution cations and anions may be used alone or in combinations of two or more.

Solvents include, but are not limited to, dimethyl ether, diethylene glycol dimethyl ether, triethylene glycol dimethyl ether, acetonitrile, dimethyl carbonate, diethyl carbonate, ethylmethyl carbonate, ethylene carbonate, propylene carbonate, chloroethylene carbonate, fluoroethylene carbonate, difluoroethylene carbonate, trifluoromethylpropylene carbonate, methylacetate, ethylacetate, propylacetate, methylpropionate, ethylpropionate, nonafluorobutylmethyl ether, nonafluorobutylethyl ether, tetrafluoroethyltetrafluoropropyl ether, triethyl phosphate, and triethyl phosphate. These solvents may be used alone or in combinations of two or more.

The functional layer 122a has a surface facing the negative electrode 130 and suppresses the formation of dendrites on the surface of the negative electrode 130. Because the solid-state battery 100 includes the functional layer 122a, the formation of dendrites on the surface of the negative electrode 130 can be suppressed when metal precipitates on the surface of the negative electrode 130 and the precipitated metal dissolves. As a result, problems such as short-circuiting and capacity loss due to the formation of dendrites on the negative electrode 130 can be suppressed, and a solid-state battery 100 with excellent cycle property can be obtained.

In the present specification, “suppressing the formation of dendrites on the surface of the negative electrode” means keeping the carrier metal precipitates formed on the surface of the negative electrode from becoming dendrite-like due to repeated charging and discharging of the solid-state battery. In other words, it means inducing carrier metal precipitates formed on the surface of the negative electrode to grow in a non-dendritic form during charging and discharging or repeated charging and discharging of the solid-state battery. Here, the “non-dendrite form” typically means a plate-like form, peak-like form and valley-like form.

A “layer having a surface facing the negative electrode” means a layer in which at least 50% or more of the surface area of the solid electrolyte faces the negative electrode. Therefore, a functional layer 122a may be formed to include pores within a range that satisfies this condition. When pores are formed in the functional layer 122a, these pores may be filled with the solid polymer electrolyte layer 121, may be filled with other components, or may be filled with a gas such as air. The surface of the solid electrolyte facing the negative electrode does not necessarily have to be in contact with the negative electrode. For example, a solid electrolyte interface layer (SEI layer) described later may be provided between the solid electrolyte and the negative electrode.

From the standpoint of the solid electrolyte 120 further suppressing the formation of dendrites on the negative electrode 130, the surface of the solid electrolyte 120 facing the negative electrode 130 belonging to the functional layer 122a is preferably 60% or more, more preferably 70% or more, even more preferably 90% or more, and still more preferably 100%.

From the standpoint of further suppressing the formation of dendrites on the negative electrode 130, the average thickness of the functional layer 122a is preferably 0.5 μm or more and 10.0 μm or less, more preferably 1.0 μm or more and 9.0 μm or less, and even more preferably 1.5 μm or more and 8.0 μm or less.

There are no particular restrictions on the functional layer 122a as long as it suppresses the formation of dendrites on the surface of the negative electrode 130. However, it preferably has at least one of ionic conductivity and electron conductivity, and more preferably has ionic conductivity. In this aspect of the present invention, the voltage applied to the interface between the functional layer 122a and the negative electrode 130 becomes more uniform in the in-plane direction of the negative electrode 130, and the functional layer 122a can further suppress the formation of dendrites on the surface of the negative electrode 130.

The second resin in the functional layer 122a is at least one type selected from a group consisting of fluororesins having fluorine in the main chain, aromatic resins having an aromatic ring in the main chain, imide resins, amide resins, and aramid resins. This aspect of the present invention is able to further suppress the formation of dendrites on the surface of the negative electrode 130, and this is believed to be due to the following factors. The factors may not be limited to the following factors.

When the functional layer 122a contains a relatively rigid resin as listed above, a rigid resin net is formed. When the functional layer 122a also contains a lithium salt, the lithium salt is uniformly arranged on the rigid resin net, lithium ions are supplied uniformly over the surface of the negative electrode 130 in the in-plane direction, and lithium metal foil is deposited uniformly in the in-plane direction. Also, when the functional layer 122a contains a filler and non-uniform carrier metal precipitation occurs on the surface of the negative electrode 130 to form dendrites, physical pressure acts on the dendrites in the direction from the functional layer 122a toward the negative electrode 130 to suppress the growth of the dendrites.

The preferred lithium salts for the functional layer 122a are the same as those for the solid polymer electrolyte layer 121.

Fillers in the functional layer 122a include, but are not limited to, metal oxides such as silica, potassium titanate and Al₂O₃, metal fluorides such as FeF₃ and AlF₃, metal carbonates such as CaCO₃, metal hydroxides such as Ca(OH)₂ and Mg(OH)₂, nitrides such as AlN and BN, and fiber materials such as carboxymethyl cellulose and carbon fibers. From the standpoint of improving the interaction with the carrier metal and further suppressing the formation of dendrites, the filler is preferably an inorganic salt. Among these, the filler is more preferably a metal hydroxide such as Ca(OH)₂ and Mg(OH)₂. The fillers may be used alone or in combinations of two or more.

The amount of second resin in the functional layer 122a may be 10% by mass or more and 95% by mass or less, 20% by mass or more and 80% by mass or less, and 30% by mass or more and 70% by mass or less relative to the total mass of the functional layer.

The amount of lithium salt in the functional layer 122a is preferably 0.5 parts by mass or more and 50.0 parts by mass or less, more preferably 1.0 parts by mass or more and 30.0 parts by mass or less, and even more preferably 2.0 parts by mass or more and 10.0 parts by mass or less with respect to 100 parts by mass of the second resin. When the amount of lithium salt is in this range, more lithium ions are supplied more uniformly to the surface of the negative electrode 130 in the in-plane direction, and a more uniform lithium metal foil is deposited in the in-plane direction.

The amount of filler in the functional layer 122a is preferably 0.5 parts by mass or more and 30.0 parts by mass or less, more preferably 1.0 part by mass or more and 20.0 parts by mass or less, and even more preferably 2.0 parts by mass or more and 10.0 parts by mass or less with respect to 100 parts by mass of the second resin. When the amount of filler is in this range, growth of dendrites can be further suppressed.

The functional layer 122a may contain components other than the second resin, the lithium salt, and the filler. These other components include, but are not limited to, resins other than the second resin, salts other than lithium salts, and solvents.

There are no particular restrictions on the resins other than the second resin that can be used. These may be one of the examples of a first resin listed above. The salts other than lithium salts and the solvents can be any salts other than a lithium salt and any solvent that can be included in the solid polymer electrolyte layer 121.

When the solid-state battery 100 in the present embodiment has a configuration described above, it has the high energy density and excellent cycle property described below. First, while it is difficult to increase the energy density of a solid-state battery including a negative electrode containing a negative electrode active material due to the presence of the negative electrode active material, the solid-state battery 100 in the present embodiment includes a negative electrode 130 that does not contain a negative electrode active material, so this problem does not occur. In other words, the solid-state battery 100 in the present embodiment has a high energy density because metal is deposited on the surface of the negative electrode 130 and the deposited metal is dissolved thereby to perform charging and discharging.

Second, because the solid-state battery 100 in the present embodiment includes a solid electrolyte 120 with a functional layer 122a that suppresses the formation of dendrites, the formation of dendrites on the surface of the negative electrode 130 can be suppressed when metal is deposited on the surface of the negative electrode 130 and the deposited metal is dissolved. As a result, problems such as short-circuiting and capacity loss due to the formation of dendrites on the negative electrode 130 can be suppressed, and the resulting cycle property is excellent. In the solid-state battery 100 of the present embodiment, the factors related to high energy density and excellent cycle property is not limited to the reasons provided above.

### Solid-State Battery Production Method

There are no particular restrictions on the method used to produce the solid-state battery 100 as long as it can produce a solid-state battery with the configuration described above. The following method is an example.

The positive electrode 110 may be produced in the following manner. A positive electrode active material mentioned above, a known conductive aid, and a known binder are mixed together to obtain a positive electrode mixture. The mixing ratio may be, for example, 50% by mass or more and 99% by mass or less of the positive electrode active material, 0.5% by mass or less of 30% by mass of the conductive aid, and 0.5% by mass or less of 30% by mass of the binder relative to the entire mass of the positive electrode mixture. The resulting positive electrode mixture is applied to one side of metal foil (for example, Al foil) with a thickness of, for example, 5 μm or more and 1 mm or less, and then press-molded. The resulting molded material is punched to a predetermined size to obtain a positive electrode 110.

Examples of conductive aids that can be used include carbon black, single-wall carbon nanotubes (SW-CNT), multi-wall carbon nanotubes (MW-CNT), carbon nanofibers, and acetylene black. Examples of binders include polyvinylidene fluoride (PVDF), polytetrafluoroethylene (PTFE), styrene butadiene rubber (SBR), acrylic resins, and polyimide resins.

Next, a metal foil with a thickness of 1 μm or more and 1 mm or less (for example, electrolytic Cu foil) is washed with a solvent containing sulfamic acid, punched to a predetermined size, washed ultrasonically with ethanol, and then dried to obtain a negative electrode.

The solid electrolyte 120 may be produced, for example, in the following manner. A resin commonly used in a solid polymer electrolyte layer (for example, the first resin described above) and a lithium salt described above are dissolved in an organic solvent. The resulting solution is then cast on a molding substrate to a predetermined thickness to obtain a solid polymer electrolyte layer 121. Here, the mixing ratio of the resin and the lithium salt may be determined based on the ratio ([Li]/[O]) of the oxygen atoms in the resin and the lithium atoms in the lithium salt, as described above. This ratio ([Li]/[O]) may be, for example, 0.02 or more and 0.20 or less. There are no particular restrictions on the organic solvent that is used, which may be, for example, acetonitrile. There are no particular restrictions on the organic molding substrate that is used, which may be, for example, a PET film or a glass substrate. There are no particular restrictions on the thickness of the resulting solid polymer electrolyte layer, which may be, for example, 10 μm or more and 100 μm or less.

Next, the functional layer 122a is formed on one side of the solid polymer electrolyte layer 121. There are no particular restrictions on the production method as long as it can produce a functional layer that suppresses the formation of dendrites on the surface of the negative electrode 130. For example, the functional layer 122a can be formed in the following manner. A mixture of a second resin mentioned above, a lithium salt mentioned above, and a filler mentioned above is dissolved in an organic solvent. The resulting solution is applied to one side of the solid polymer electrolyte layer 121 to a predetermined thickness using a bar coater to obtain a solid electrolyte 120 in which the functional layer 122a is arranged on the solid polymer electrolyte layer 121. Here, the mixing ratio for the second resin, the lithium salt, and the filler can be, for example, 1 part by mass or more and 50 parts by mass or less of the lithium salt and 1 part by mass or more and 30 parts by mass of the filler with respect to 100 parts by mass of the second resin. There are no particular restrictions on the organic solvent that is used, which may be, for example, a mixed solvent of dimethylacetamide (DMAc) and tripropylene glycol (TPG) (DMAc: TPG=50:50 to 90:10 (% by volume)).

Holes may be drilled in the solid polymer electrolyte layer 121, the functional layer 122a, and the solid electrolyte 120 when appropriate.

A solid-state battery 100 can be obtained by laminating the positive electrode 110, the solid electrolyte 120, and the negative electrode 130 obtained above in this order so that the functional layer 122a faces the negative electrode 130.

### Use of Solid-State Battery

FIG. 2 is a schematic diagram showing one use for the solid-state battery in the present embodiment. The solid-state battery 200 comprises a positive electrode 110, a solid electrolyte 120 including a solid polymer electrolyte layer 121 and a functional layer 122a, a negative electrode 130 that is free of negative electrode active material, and a positive electrode current collector 210 bonded to the positive electrode 110. A positive electrode terminal 230 and a negative electrode terminal 240 used to connect to an external circuit are mounted on the positive electrode current collector 210 and the negative electrode 130. In the solid-state battery 200, a solid electrolyte interface layer (SEI layer) 220 is formed during initial charging. There are no particular restrictions on the SEI layer 220 that is formed, which may contain, for example, an inorganic substance of the carrier metal and an organic substance of the carrier metal. The average thickness of the SEI layer is typically 1 μm or more and 10 μm or less.

The solid-state battery 200 is charged by applying voltage between the positive electrode terminal 230 and the negative electrode terminal 240 so that current flows from the negative electrode terminal 240 to the positive electrode terminal 230 via an external circuit. By charging the solid battery 200, a carrier metal is deposited at the interface between the negative electrode 130 and the solid electrolyte interface layer (SEI layer) 220 and/or at the interface between the solid electrolyte interface layer (SEI layer) 220 and the functional layer 122a. The deposited carrier metal is kept from growing in a dendrite-like form due to the influence of the functional layer 122a, and typically grows on thin film.

When the positive electrode terminal 230 and the negative electrode terminal 240 in a charged solid-state battery 200 are connected, the solid-state battery 200 discharges. The precipitate of the carrier metal produced at the interface between the negative electrode 130 and the solid electrolyte interface layer (SEI layer) 220 and/or at the interface between the solid electrolyte interface layer (SEI layer) 220 and the functional layer 122a is dissolved.

### 2nd Embodiment

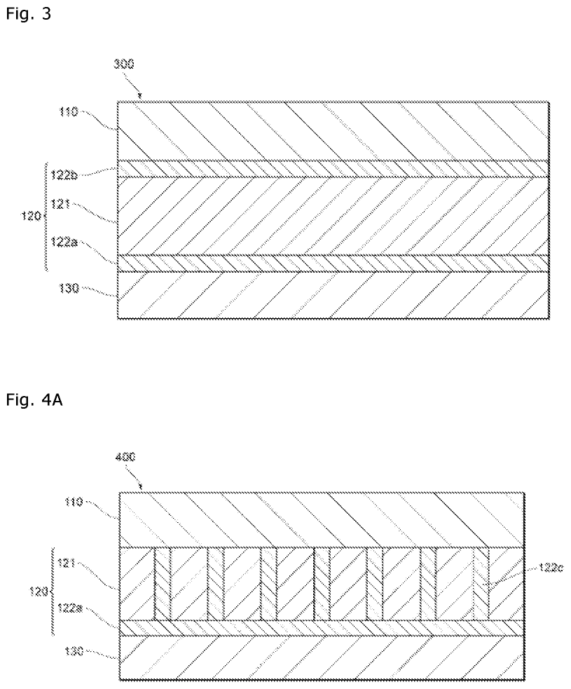

In the solid-state battery 300 of the second embodiment shown in FIG. 3, functional layers 122a, 122b are arranged on both sides of the solid polymer electrolyte layer 121. In other words, a functional layer 122a is formed on one surface (the lower surface) of the solid polymer electrolyte layer 121, and a functional layer 122b is formed on the other surface (the upper surface) of the solid polymer electrolyte layer 121. As a result, functional layer 122a has a surface facing the negative electrode 130, and functional layer 122b has a surface facing the positive electrode 110. In this aspect of the present invention, even if dendrites form on the surface of the negative electrode 130, when the dendrites reach functional layer 122b, physical pressure and/or electrostatic interaction in the direction from the functional layer 122b to the negative electrode 130 acts on the dendrites to suppress growth of the dendrites. As a result, the dendrites formed on the surface of the negative electrode 130 are kept from reaching the positive electrode 110 and short-circuiting the battery.

Functional layer 122b is identical to functional layer 122a, and differs only in terms of the arrangement. This solid-state battery 200 can be produced by forming functional layers 122a, 122b on both sides of the solid polymer electrolyte layer 121 using the method for producing the solid-state battery 100 described above. Note that functional layer 122b does not have to be the same as functional layer 122a, and may, for example, differ from functional layer 122a in terms of the materials used or the compositional ratio.

### 3rd Embodiment

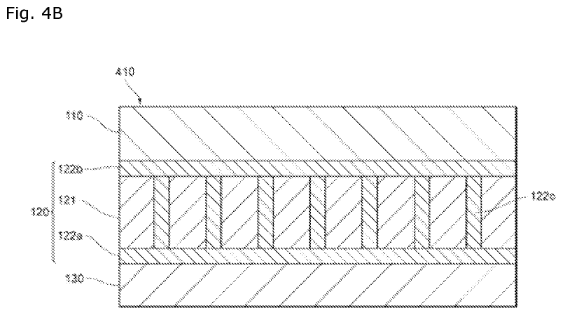

The solid-state battery 400 in the third embodiment shown in FIG. 4A has traversing portions 122c, which are portions of the functional layer 122a which are arranged so as to traverse the solid polymer electrolyte layer 121 in the lamination direction of the solid-state battery 400. In this aspect of the present invention, uniform lithium ion conduction occurs at least in the traversing portions 122c, so that a more uniform supply of lithium ions is provided on the surface of the negative electrode 130 in the in-plane direction, and the formation of dendrites can be further suppressed.

The traversing portions 122c are identical to the functional layer 122a, and differ only in arrangement. The cross-sectional profile of the traversing portions 122c is not restricted, and may be polygonal, circular, or oval-shaped. The cross-sectional area of the traversing portions 122c is not restricted, and may be 1 μm² or more and 10 cm² or less, 10 μm² or more and 5 cm² or less, or 100 μm² or more and 1 cm² or less. The traversing portions 122c do not have to be identical to the functional layer 122a. For example, the material and the component ratio may differ from that of the functional layer 122a.

This solid-state battery 400 can be produced using the production method for solid-state battery 100 in which after forming the solid polymer electrolyte layer 121 and drilling holes, the functional layer 122a is formed and the holes drilled in the solid polymer electrolyte layer 121 are filled with the material used to form the functional layer 122a in order to form the traversing portions 122c. Alternatively, after forming the functional layer 122a on the solid polymer electrolyte layer 121, holes are drilled that pass through the solid polymer electrolyte layer 121 and the functional layer 122a, and these holes are filled with the same material as that of the functional layer 122a to form the traversing portions 122c.

### 4th Embodiment

In the solid-state battery 410 of the fourth embodiment shown in FIG. 4B, functional layer 122a and functional layer 122b are connected via traversing portions 122c. This aspect of the present invention combines the effects of the second embodiment and the third embodiment. In other words, this aspect can keep the formation of dendrites on the surface of the negative electrode 130 from reaching the positive electrode 110 and causing short-circuiting inside the battery, and can further suppress the formation of dendrites on the surface of the negative electrode 130.

This solid-state battery 410 can be produced using the production method for solid-state battery 100 in which after forming the solid polymer electrolyte layer 121 and drilling holes, functional layer 122a and functional layer 122b are formed on both sides of the solid polymer electrolyte layer 121, and the holes drilled in the solid polymer electrolyte layer 121 are filled with the material used to form functional layer 122a and functional layer 122b to form the traversing portions 122c. Alternatively, after forming functional layer 122a and functional layer 122b on the solid polymer electrolyte layer 121, holes are drilled that pass through the solid polymer electrolyte layer 121, functional layer 122a, and functional layer 122b, and these holes are filled with the same material as that of functional layer 122a to form the traversing portions 122c and complete the solid-state battery 410.

The embodiments described above are mere examples used to explain the present invention, and the scope of the present invention is not limited to these embodiments alone. Many variations are possible that do not depart from the scope and spirit of the present invention.

For example, the solid-state battery of the present embodiment may be a solid-state secondary battery. The solid-state battery of the present embodiment may also be a lithium secondary battery in which charging and discharging are performed by depositing lithium metal on the surface of the negative electrode on which an SEI layer is formed, and dissolving the deposited lithium. From the standpoint of effectively and reliably realizing the effect of the present embodiment, the solid-state battery in the present embodiment is preferably a solid-state secondary battery, and more preferably a lithium secondary battery in which charging and discharging are performed by depositing lithium metal on the surface of the negative electrode on which an SEI layer is formed, and dissolving the deposited lithium.

In the solid-state battery of the present embodiment, lithium foil may not be formed between the solid electrolyte and the negative electrode prior to the initial charge. When lithium foil is not formed between the solid electrolyte and the negative electrode in the solid-state battery of the present embodiment prior to the initial charge, highly flammable lithium metal does not have to be used during production, and a solid-state battery with better safety and higher productivity is realized.

The solid-state battery in the present embodiment may have a solvent. There are no particular restrictions, and this may be any solvent that the solid polymer electrolyte layer 121 can contain.

The solid-state battery in the present embodiment may have a current collector arranged so as to be in contact with the negative electrode or the positive electrode. There are no particular restrictions, and this may be any current collector that can be used with a negative electrode material. When the solid-state battery does not have a current collector, the negative electrode and the positive electrode themselves act as current collectors.

The solid-state battery in the present embodiment may have a sealed container used to seal the positive electrode, the solid electrolyte, and the negative electrode. When the solid-state battery contains a solvent, the solid-state battery preferably has a sealed container. There are no particular restrictions on the sealed container, which may be an outer shell such as a laminated film.

In the solid-state battery of the present embodiment, terminals used to connect to an external circuit may be mounted on the positive electrode and the negative electrode. For example, metal terminals of 10 μm or more and 1 mm or less (for example, Al, Ni, etc.) may be bonded to one or both of the positive electrode and the negative electrode. Any method common in the art can be used as the joining method, such as ultrasonic welding.

The solid-state battery in the present embodiment may be a two-layer solid-state battery in which a solid electrolyte is provided on both sides of the negative electrode and a positive electrode is placed on the surface of each solid electrolyte facing the negative electrode.

The uses of the solid-state battery of the present embodiment described above are merely examples, and the present invention is not limited to these examples. For example, an SEI layer does not have to be formed when the solid-state battery in the present embodiment is used.

In the present specification, “the energy density is high” and “high energy density” mean the capacity is high relative to the total volume or total mass of the battery. This is preferably 900 Wh/L or more or 400 Wh/kg or more, and more preferably 1000 Wh/L or more or 430 Wh/kg or more.

In the present specification, “excellent in cycle property” means that the rate of decline in battery capacity is low after a number of charge/discharge cycles that can be expected during normal use. In other words, when comparing the initial capacity to the capacity after the number of charge/discharge cycles that can be expected during normal use, the capacity after the charge/discharge cycles has declined much relative to the initial capacity. Here, the “number of times that can be expected during normal use” can be, for example, 50 times, 100 times, 500 times, 1000 times, 5000 times, or 10000 times, depending on the application for the solid-state battery. “The capacity has declined much after the charge/discharge cycles relative to the initial capacity” depends on the application for the solid-state battery. For example, it may mean that the capacity after the charge/discharge cycles is 65% or more, 70% or more, 75% or more, 80% or more, 85% or more, or 90% or more of the initial capacity.

### EXAMPLES

The following is a more detailed description of the present invention with reference to examples and comparative examples. The present invention is not limited in any way by these examples.

### Example 1

A mixture of 96 parts by mass of LiNi_{0.8}Co_{0.15}Al_{0.05}O₂ as the positive electrode active material, 2 parts by mass of carbon black as a conductive aid, and 2 parts by mass of polyvinylidene fluoride (PVDF) as a binder was applied to one side of 12 μm Al foil, which was then press-molded. The resulting molded material was punched to a size of 4.0 cm×4.0 cm to obtain a positive electrode.

Next, 6 μm electrolytic Cu foil was washed with a solvent containing sulfamic acid, punched to a size of 4.5 cm×4.5 cm, washed ultrasonically with ethanol, and then dried to obtain a negative electrode.

Next, an ethylene oxide/ethylene glycol ether copolymer (“P(EO/MEEGE)”) (average molecular weight of 1.5 million) and LiN(SO₂F)₂ (“LFSI”) were dissolved in acetonitrile at a blending ratio that resulted in a ratio ([Li]/[O]) of lithium atoms in the lithium salt to oxygen atoms in the resin of 0.07. The resulting solution was cast onto a molding substrate to a predetermined thickness in order to obtain a solid polymer electrolyte layer.

Next, 5% by mass of both Ca(OH)₂ and LFSI were added to polyvinylidene fluoride (PVDF). The resulting mixture was dissolved in a mixed solvent of dimethylacetamide (DMAc) and tripropylene glycol (TPG) (DMAc:TPG=90:10 (% by volume)) and applied to one side of the solid polymer electrolyte layer obtained above using a bar coater to form a functional layer on one side of the solid polymer electrolyte layer. This was used as the solid electrolyte.

The positive electrode, the solid electrolyte, and the negative electrode obtained in the manner described above were laminated in this order to obtain a laminate with the functional layer facing the negative electrode. Next, a 100 μm Al terminal and a 100 μm Ni terminal were joined to the positive electrode and the negative electrode, respectively, by ultrasonic welding, and then inserted into the outer shell of the laminate. Next, a dimethoxyethane (DME) solution of 4M LFSI was injected into the outer shell as an electrolytic solution. The outer shell was then sealed to obtain a solid-state battery.

### Example 2

A solid-state battery was obtained in the same manner as Example 1 except that a mixture in which 5% by mass of both Ca(OH)₂ and LFSI were added to an aramid was used during functional layer formation instead of the mixture in which 5% by mass of both Ca(OH)₂ and LFSI were added to polyvinylidene fluoride (PVDF).

### Example 3

A solid-state battery was obtained in the same manner as Example 1 except that a mixture in which 5% by mass of both Mg(OH)₂ and LFSI were added to polyvinylidene fluoride (PVDF) was used during functional layer formation instead of the mixture in which 5% by mass of both Ca(OH)₂ and LFSI were added to polyvinylidene fluoride (PVDF).

### Example 4

A solid-state battery was obtained in the same manner as Example 1 except that a mixture in which 5% by mass of both Mg(OH)₂ and LFSI were added to an aramid was used during functional layer formation instead of the mixture in which 5% by mass of both Ca(OH)₂ and LFSI were added to polyvinylidene fluoride (PVDF).

### Example 5

A solid-state battery was obtained in the same manner as Example 1 except that a mixture in which 2% by mass, 3% by mass, and 5% by mass, respectively, of Mg(OH)₂, LiSO₃CF₃ (“LiTA”), and LFSI were added to an aramid was used during functional layer formation instead of the mixture in which 5% by mass of both Ca(OH)₂ and LFSI were added to polyvinylidene fluoride (PVDF).

### Example 6

A solid-state battery was obtained in the same manner as Example 1 except that a mixture in which 5% by mass of both Ca(OH)₂ and LiF were added to polyvinylidene fluoride (PVDF) was used during functional layer formation instead of the mixture in which 5% by mass of both Ca(OH)₂ and LFSI were added to polyvinylidene fluoride (PVDF).

### Example 7

A solid-state battery was obtained in the same manner as Example 1 except that a mixture in which 2% by mass, 3% by mass, and 5% by mass, respectively, of Ca(OH)₂, LiF, and LFSI were added to polyvinylidene fluoride (PVDF) was used during functional layer formation instead of the mixture in which 5% by mass of both Ca(OH)₂ and LFSI were added to polyvinylidene fluoride (PVDF).

### Example 8

A solid-state battery was obtained in the same manner as Example 1 except that a mixture of LFSI and LiN(SO₂CF₃)₂(“LTFSI”) (LFSI:LTFSI=50:50 (% by mass)) was used instead of LFSI during solid polymer electrolyte layer formation, and that a mixture in which 2% by mass, 3% by mass, and 5% by mass, respectively, of Ca(OH)₂, LiF, and LiNO₃ were added to polyvinylidene fluoride (PVDF) was used during functional layer formation instead of the mixture in which 5% by mass of both Ca(OH)₂ and LFSI were added to polyvinylidene fluoride (PVDF).

### Example 9

A solid-state battery was obtained in the same manner as Example 1 except that a mixture in which 5% by mass of both Ca(OH)₂ and LiTA were added to polyvinylidene fluoride (PVDF) was used during functional layer formation instead of the mixture in which 5% by mass of both Ca(OH)₂ and LFSI were added to polyvinylidene fluoride (PVDF).

### Example 10

A solid-state battery was obtained in the same manner as Example 1 except that a mixture of polyvinylidene fluoride (PVDF) and hexafluoropropylene (HFP) (PVDF:HFP=80:20 (% by volume) was used instead of ethylene oxide/ethylene glycol ether copolymer (P(EO/MEEGE)) (average molecular weight 1.5 million) during solid polymer electrolyte layer formation, and that a mixture in which 3% by mass of both Mg(OH)₂ and LFSI were added to polyvinylidene fluoride (PVDF) was used during functional layer formation instead of the mixture in which 5% by mass of both Ca(OH)₂ and LFSI were added to polyvinylidene fluoride (PVDF).

### Example 11

A solid-state battery was obtained in the same manner as Example 10 except that polymethyl methacrylate (PMMA) was used instead of a mixture of polyvinylidene fluoride (PVDF) and hexafluoropropylene (HFP) and a mixture of LFSI and LiN(SO₂CF₃)₂(“LTFSI”) (LFSI:LTFSI=50:50 (% by mass)) was used instead of LFSI during solid polymer electrolyte layer formation.

### Example 12

A solid-state battery was obtained in the same manner as Example 1 except that a mixture in which 3% by mass of both Ca(OH)₂ and LFSI were added to polyimide was used during functional layer formation instead of the mixture in which 5% by mass of both Ca(OH)₂ and LFSI were added to polyvinylidene fluoride (PVDF).

### Example 13

A solid-state battery was obtained in the same manner as Example 8 except that a dimethoxyethane (DME)/tetrafluoroethylene tetrafluoropropyl ether (TTFE) solution of 4M LFSI (DME:TTFE=90:10 (% by volume)) was used instead of a dimethoxyethane (DME) solution of 4M LFSI as the electrolyte injected into the outer shell.

### Example 14

A solid-state battery was obtained in the same manner as Example 10 except that a dimethoxyethane (DME)/tetrafluoroethylene tetrafluoropropyl ether (TTFE) solution of 4M LFSI (DME:TTFE=90:10 (% by volume)) was used instead of a dimethoxyethane (DME) solution of 4M LFSI as the electrolyte injected into the outer shell.

### Example 15

A solid-state battery was obtained in the same manner as Example 12 except that a dimethoxyethane (DME)/tetrafluoroethylene tetrafluoropropyl ether (TTFE) solution of 4M LFSI (DME:TTFE=90:10 (% by volume)) was used instead of a dimethoxyethane (DME) solution of 4M LFSI as the electrolyte injected into the outer shell.

### Comparative Example 1

A solid-state battery was obtained in the same manner as Example 1 except that a 25 μm polyethylene microporous film was used instead of a solid electrolyte.

### Comparative Example 2

A solid-state battery was obtained in the same manner as Example 1 except that a functional layer was not formed on the solid polymer electrolyte layer.

### Evaluation of Energy Density and Cycle Property

The energy density and cycle property of the solid-state batteries produced in each of the examples and comparative examples were evaluated as follows.

The solid-state battery was charged at 7 mA until the voltage reached 4.2 V, and then discharged at 7 mA until the voltage reached 3.0 V (“initial discharge”). Then, a cycle of charging at 35 mA until the voltage reached 4.2 V and discharging at 35 mA until the voltage reached 3.0 V was repeated for 100 cycles at a temperature of 25° C. Table 1 shows the capacity obtained from the initial discharge (“initial capacity”) and the capacity obtained from the discharge after 100 cycles (“capacity retention”) for each example and comparative example. For comparative purposes, the initial capacity of Comparative Example 1 was used to establish the value for 100. The initial capacity of Comparative Example 1 was 70 mWh.

TABLE 1

| | Solid Polymer Electrolyte Layer | | Functional Layer | |
|---|---|---|---|---|
| | Resin | Lithium Salt | Resin | Filler and Salt |
| Ex. 1 | P(EO/MEEGE) | LFSI | PVDF | Ca(OH)₂-LFSI |
| Ex. 2 | P(EO/MEEGE) | LFSI | Aramid | Ca(OH)₂-LFSI |
| Ex. 3 | P(EO/MEEGE) | LFSI | PVDF | Mg(OH)₂-LFSI |
| Ex. 4 | P(EO/MEEGE) | LFSI | Aramid | Mg(OH)₂-LFSI |
| Ex. 5 | P(EO/MEEGE) | LFSI | Aramid | Mg(OH)₂-LFSI- |
| | | | | LiTA |
| Ex. 6 | P(EO/MEEGE) | LFSI | PVDF | Ca(OH)₂-LiF |
| Ex. 7 | P(EO/MEEGE) | LFSI | PVDF | Ca(OH)₂-LFSI- |
| | | | | LiF |
| Ex. 8 | P(EO/MEEGE) | LFSI-LTFSI | PVDF | Ca(OH)₂-LiF- |
| | | | | LiNO₃ |
| Ex. 9 | P(EO/MEEGE) | LFSI | PVDF | Ca(OH)₂-LiTA |
| Ex. 10 | PVDF/HFP | LFSI | PVDF | Mg(OH)₂-LFSI |
| Ex. 11 | PMMA | LFSI-LTFSI | PVDF | Mg(OH)₂-LFSI |
| Ex. 12 | P(EO/MEEGE) | LFSI | Polyimide | Ca(OH)₂-LFSI |
| Ex. 13 | P(EO/MEEGE) | LFSI-LTFSI | PVDF | Ca(OH)₂-LiF- |
| | | | | LiNO₃ |
| Ex. 14 | PVDF/HFP | LFSI | PVDF | Mg(OH)₂-LFS |
| Ex. 15 | P(EO/MEEGE) | LFSI | Polyimide | Ca(OH)₂-LFSI |
| C. Ex. | PE | — | — | — |
| 1 | | | | |
| C. Ex. | P(EO/MEEGE) | LFSI | — | — |
| 2 | | | | |

| | | | Capacity Retention |
|---|---|---|---|
| | Electrolyte | Initial Capacity (—) | (—) |
| Ex. 1 | DME-LFSI | 100 | 85 |
| Ex. 2 | DME-LFSI | 99 | 86 |
| Ex. 3 | DME-LFSI | 101 | 82 |
| Ex. 4 | DME-LFSI | 97 | 85 |
| Ex. 5 | DME-LFSI | 102 | 88 |
| Ex. 6 | DME-LFSI | 98 | 87 |
| Ex. 7 | DME-LFSI | 103 | 86 |
| Ex. 8 | DME-LFSI | 99 | 84 |
| Ex. 9 | DME-LFSI | 101 | 88 |
| Ex. 10 | DME-LFSI | 99 | 85 |
| Ex. 11 | DME-LFSI | 98 | 84 |
| Ex. 12 | DME-LFSI | 99 | 87 |
| Ex. 13 | (DME/TTFE)- | 100 | 88 |
| | LFSI | | |
| Ex. 14 | (DME/TTFE)- | 101 | 89 |
| | LFSI | | |
| Ex. 15 | (DME/TTFE)- | 99 | 84 |
| | LFSI | | |
| C. Ex. | DME-LFSI | 100 | 20 |
| 1 | | | |
| C. Ex. | DME-LFSI | 82 | 70 |
| 2 | | | |

### INDUSTRIAL APPLICABILITY

Because a solid-state battery of the present invention has high energy density and excellent cycle property, it has industrial applicability as a power storage device used in various applications.

### REFERENCE SIGNS LIST

100, 200, 300, 400, 410: Solid-state battery
110: Positive electrode
120: Solid electrolyte
121: Solid polymer electrolyte layer
122a, 122b: Functional layer
122c: Traversing portion
130: Negative electrode
210: Positive electrode current collector
220: Solid electrolyte interface layer (SEI layer)
230: Positive electrode terminal
240: Negative electrode terminal

What is claimed:

1. A solid-state battery comprising a positive electrode, a solid electrolyte, and a negative electrode that is free of a negative-electrode active material,
wherein the solid electrolyte has a solid polymer electrolyte layer, and a functional layer that has a surface facing at least the negative electrode and that suppresses the formation of dendrites on the surface of the negative electrode.

2. The solid-state battery according to claim 1, wherein the functional layer is arranged on only one side of the solid polymer electrolyte layer.

3. The solid-state battery according to claim 1, wherein the functional layer is arranged on both sides of the solid polymer electrolyte layer.

4. The solid-state battery according to claim 2, wherein the functional layer has a portion arranged so as to traverse the solid polymer electrolyte layer.

5. The solid-state battery according to claim 1, wherein the solid-state battery is a lithium secondary battery in which charging and discharging are performed by depositing lithium metal on the surface of the negative electrode and dissolving the deposited lithium.

6. The solid-state battery according to claim 1, wherein the negative electrode is a lithium-free electrode.

7. The solid-state battery according to claim 1, wherein lithium foil is not formed between the solid electrolyte and the negative electrode prior to the initial charge.

8. The solid-state battery according to claim 1, wherein the solid polymer electrolyte layer has ionic conductivity and not electron conductivity, and has conductivity of 0.10 mS/cm or more, and
the functional layer has at least one of ionic conductivity and electron conductivity.

9. The solid-state battery according to claim 1, wherein the solid polymer electrolyte layer comprises a first resin and a lithium salt, the first resin being at least one selected from a group consisting of resins having an ethylene oxide unit in a main chain and/or a side chain, acrylic resins, vinyl resins, ester resins, and nylon resins, and
the functional layer comprises a second resin, a lithium salt, and a filler, the second resin being at least one selected from a group consisting of fluororesins having fluorine in a main chain, aromatic resins having an aromatic ring in a main chain, imide resins, amide resins, and aramid resins.

10. The solid-state battery according to claim 9, wherein the filler is an inorganic salt.

11. The solid-state battery according to claim 9, wherein the amount of the lithium salt in the functional layer is 0.5 parts by mass or more and 50.0 parts by mass or less with respect to 100 parts by mass of the second resin.

12. The solid-state battery according to claim 9, wherein the amount of the filler is 0.5 parts by mass or more and 30.0 parts by mass or less with respect to 100 parts by mass of the second resin.

13. The solid-state battery according to claim 1, wherein the average thickness of the functional layer facing the negative electrode is 0.5 μm or more and 10.0 μm or less.

14. The solid-state battery according to claim 1, wherein the positive electrode has a positive electrode active material.

15. The solid-state battery according to claim 8, wherein the solid-state battery is a lithium secondary battery in which charging and discharging are performed by depositing lithium metal on the surface of the negative electrode and dissolving the deposited lithium.

16. The solid-state battery according to claim 8, wherein the negative electrode is a lithium-free electrode.

17. The solid-state battery according to claim 8, wherein lithium foil is not formed between the solid electrolyte and the negative electrode prior to the initial charge.

18. The solid-state battery according to claim 9, wherein the solid-state battery is a lithium secondary battery in which charging and discharging are performed by depositing lithium metal on the surface of the negative electrode and dissolving the deposited lithium.

19. The solid-state battery according to claim 9, wherein the negative electrode is a lithium-free electrode.

20. The solid-state battery according to claim 9, wherein lithium foil is not formed between the solid electrolyte and the negative electrode prior to the initial charge
